(19) United States
(12) Patent Application Publication
(10) Pub. No.: US 2026/0078238 A1
(43) Pub. Date: Mar. 19, 2026

(54) POLYVINYL CHLORIDE COMPOSITION AND PLASTIC FLOOR TILE

(71) Applicant: NAN YA PLASTICS CORPORATION, TAIPEI (TW)

(72) Inventors: CHING-YAO YUAN, TAIPEI (TW); CHUN-CHE TSAO, TAIPEI (TW); Chen-Ho Lai, TAIPEI (TW)

(21) Appl. No.: 18/954,671

(22) Filed: Nov. 21, 2024

(30) Foreign Application Priority Data
Sep. 16, 2024 (TW) 113135037

(51) Int. Cl. C08K 5/12; C08K 5/07; C08K 5/098; C08K 5/103; C08K 5/11; C08K 5/524; C08L 27/06; E04F 15/10

(52) U.S. Cl. CPC C08K 5/12; C08K 5/07; C08K 5/098; C08K 5/103; C08K 5/11; C08K 5/524; C08L 27/06; E04F 15/105; C08K 2201/014; C08L 2201/08; C08L 2205/06; C08L 2207/322

(57) ABSTRACT

A polyvinyl chloride composition and a plastic floor tile are provided. The polyvinyl chloride composition includes 30 parts by weight to 60 parts by weight of a polyvinyl chloride resin, 0.5 parts by weight to 5.0 parts by weight of a plasticizer, and 1 part by weight to 8 parts by weight of a fatty acid stabilizer. The fatty acid stabilizer is a composite formula that at least includes a calcium fatty acid compound, a zinc fatty acid compound, a pentaerythritol ester compound, and a β-diketone compound. The polyvinyl chloride composition has a gelation time of not greater than 20 seconds and a thermal stability time of not less than 153 minutes at 180° C.

### CROSS-REFERENCE TO RELATED PATENT APPLICATION

This application claims the benefit of priority to Taiwan Patent Application No. 113135037, filed on Sep. 16, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a resin composition, and more particularly to a polyvinyl chloride (PVC) composition and a plastic floor tile.

### BACKGROUND OF THE DISCLOSURE

In the technical field of processing polyvinyl chloride (PVC) polymer, the use of stabilizers is important for effectively enhancing the processing stability of the PVC material and preventing PVC degradation caused by factors such as light and heat during the process.

In the related art, conventional stabilizers include lead salt stabilizers, metal soap stabilizers, organotin stabilizers, copper-zinc stabilizers, and calcium-zinc stabilizers.

The lead salt stabilizers exhibit excellent thermal stability, but due to the presence of lead (i.e., a heavy metal), the lead salt stabilizers pose serious health risks to humans and environmental pollution. Therefore, the lead salt stabilizers are gradually restricted in use. The metal soap stabilizers typically include heavy metals such as zinc, barium, and cadmium, which present potential toxicity risks to humans and the environment. The organotin stabilizers exhibit good stabilization effects in certain applications, but also present heavy metal toxicity issues. Copper-zinc stabilizers are often used in specific applications, but still contain heavy metals, which make them difficult to meet environmental protection requirements.

In addition, the calcium-zinc stabilizers are one of the eco-friendly stabilizers that are commonly used recently. The calcium-zinc stabilizer do not contain heavy metals and are friendly to the environment and human health, but the thermal resistance of the calcium-zinc stabilizers is relatively weak compared to other types of stabilizers.

PVC products are typically affected by high temperatures and ultraviolet radiation during the processing, leading to the detachment of chlorine atoms from the PVC material, which forms free radicals and causes material degradation, along with discoloration and brittleness.

To prevent the above issues, the stabilizers must be added into the PVC material to capture the free radicals and prevent the PVC material from degrading when exposed to light and heat.

Currently, commonly used stabilizers (e.g., lead, cadmium, tin metal salts) have obvious toxicity issues, posing risks to human health and causing environmental pollution. Although the calcium-zinc stabilizers are relatively safe, the thermal stability of the calcium-zinc stabilizers is relatively weak, thereby limiting their applications under high-temperature conditions. Therefore, how to enhance the thermal stability of the calcium-zinc stabilizers under the premise of being non-toxic and environmentally friendly has become an important technical challenge to be addressed in PVC products, particularly in floor tile products.

### SUMMARY OF THE DISCLOSURE

In response to the above-referenced technical inadequacies, the present disclosure discloses a polyvinyl chloride (PVC) composition and a plastic floor tile, primarily addressing the problem of heavy metal toxicity associated with conventional PVC stabilizers (e.g., lead salt stabilizers, metal soap stabilizers, organotin stabilizers) which poses hazards to human health and the environment, while also meeting the market demand for non-toxic and environmentally friendly materials.

Moreover, the polyvinyl chloride (PVC) composition of the present disclosure enhances the thermal resistance of the calcium-zinc stabilizers, which can remain stable during high-temperature processing and prevent material degradation.

In one aspect, the present disclosure provides a polyvinyl chloride composition suitable for production of plastic floor tiles. The polyvinyl chloride composition includes a polyvinyl chloride resin, a plasticizer, and a fatty acid stabilizer.

An amount of the polyvinyl chloride resin ranges from 30 parts by weight to 60 parts by weight. An amount of the plasticizer ranges from 0.5 parts by weight to 5.0 parts by weight. The fatty acid stabilizer is a composite formula and at least includes: a calcium fatty acid compound, a zinc fatty acid compound, a pentaerythritol ester compound, and a β-diketone compound. A total amount of the fatty acid stabilizer ranges from 1 part by weight to 8 parts by weight. The polyvinyl chloride composition has a gelation time of not greater than 20 seconds and a thermal stability time of not less than 153 minutes at 180° C.

In certain embodiments, in the fatty acid stabilizer, an amount of the calcium fatty acid compound ranges from 0.05 parts by weight to 0.15 parts by weight, an amount of the zinc fatty acid compound ranges from 0.18 parts by weight to 0.25 parts by weight, an amount of the pentaerythritol ester compound ranges from 1.0 part by weight to 2.0 parts by weight, and an amount of the β-diketone compound ranges from 0.8 parts by weight to 1.8 parts by weight.

In certain embodiments, the fatty acid stabilizer includes at least one of a phosphite ester, a dicarboxylic acid ester compound, and a hydrotalcite.

An amount of the phosphite ester compound ranges from 1.0 part by weight to 2.0 parts by weight. An amount of the dicarboxylic acid ester compound ranges from 0.18 parts by weight to 0.25 parts by weight. An amount of the hydrotalcite ranges from 1.0 part by weight to 2.0 parts by weight.

In certain embodiments, the polyvinyl chloride composition further includes at least one of an ultraviolet absorber, an impact modifier, and an antioxidant. An amount of the ultraviolet absorber ranges from 3.0 parts by weight to 10 parts by weight. An amount of the impact modifier ranges from 0.5 parts by weight to 5.0 parts by weight. An amount of the antioxidant ranges from 0.01 parts by weight to 2.0 parts by weight.

In certain embodiments, the polyvinyl chloride resin has a K value ranging from 45 to 80, an average degree of polymerization ranging from 500 to 2,500, an apparent density ranging from 0.4 to 0.8 g/cc, and a volatile content of not greater than 0.3%.

In certain embodiments, the plasticizer is at least one material selected from the group consisting of phthalate plasticizers, non-phthalate plasticizers, phosphate plasticizers, epoxy plasticizers, polymeric plasticizers, and citrate plasticizers.

In certain embodiments, the plasticizer includes: 0.5 parts by weight to 1.0 part by weight of the non-phthalate plasticizer, and 1.5 parts by weight to 2 parts by weight of the epoxy plasticizer.

In certain embodiments, the calcium fatty acid compound and the zinc fatty acid compound each independently have a carbon chain length of C12 to C36, a molar mass of 550 g/mol to 650 g/mol, a specific gravity of 1.0 g/cm³ to 1.60 g/cm³, and a melting point of 120° C. to 170° C.

In certain embodiments, the β-diketone compound is at least one material selected from the group consisting of stearoyl benzoyl methane, octanoyl benzoyl methane, and dibenzoyl methane.

In yet another aspect, the present disclosure provides a plastic floor tile formed of the polyvinyl chloride composition described above.

Therefore, the polyvinyl chloride composition and the plastic floor tile of the present disclosure can improve the thermal resistance of the calcium-zinc stabilizers through optimized formulations, so that the calcium-zinc stabilizers can remain stable during high-temperature processing and prevent the PVC material from degrading. Additionally, the polyvinyl chloride composition of the present disclosure improves on the problem of heavy metal toxicity present in existing PVC stabilizers (e.g., lead salt stabilizers, metal soap stabilizers, and organotin stabilizers) which poses hazards to human health and the environment, while also meeting the market demand for non-toxic and environmentally friendly materials.

These and other aspects of the present disclosure will become apparent from the following description of the embodiment taken in conjunction with the following drawings and their captions, although variations and modifications therein may be affected without departing from the spirit and scope of the novel concepts of the disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### [Polyvinyl Chloride Composition]

In a conventional method of processing polyvinyl chloride (PVC), stabilizers are important to enhance material stability and prevent degradation caused by factors such as light and heat. Conventional stabilizers used in the related art include lead salt stabilizers, metal soap stabilizers, organotin stabilizers, copper-zinc stabilizers, and calcium-zinc stabilizers. Among them, except for the calcium-zinc stabilizers, the other stabilizers, such as lead salt stabilizers, metal soap stabilizers, organotin stabilizers, and copper-zinc stabilizers, contain toxic heavy metals, which are harmful to human health and may cause environmental pollution. The calcium-zinc stabilizers are considered to be an environmentally-friendly option, but have relatively weak thermal resistance, which limits the use in high-temperature applications.

PVC products are often degraded during processing due to exposure to high temperatures or ultraviolet radiation, resulting in poor phenomena such as discoloration and brittleness. Therefore, improving the thermal resistance of the calcium-zinc stabilizers while maintaining non-toxicity and environmental friendliness has become a technical challenge in current PVC products, especially in floor tile products.

To address the technical problems in the related art, the present disclosure provides a polyvinyl chloride composition, particularly a polyvinyl chloride composition suitable for the production of plastic floor tiles. The polyvinyl chloride composition is specifically designed for environmentally-friendly PVC products and is especially applicable for PVC floor tiles that come into frequent contact with the human body. The core technology of the present disclosure lies in the use of a composite formula of calcium-zinc fatty acid stabilizers to enhance the thermal stability of the PVC material while avoiding the use of heavy metal components harmful to human health.

The polyvinyl chloride composition of the present disclosure addresses the issues of heavy metal toxicity associated with conventional PVC stabilizers (e.g., lead salt stabilizers, metal soap stabilizers, and organotin stabilizers), which have risks to human health and environment. The polyvinyl chloride composition of the present disclosure also meets the market demand for non-toxic and environmentally-friendly materials. The polyvinyl chloride composition of the present disclosure has improved heat resistance for the calcium-zinc stabilizers, which can remain stable during a high-temperature process and can prevent the resin material from degrading.

To achieve the above objectives, the polyvinyl chloride composition according to the embodiment of the present disclosure includes a polyvinyl chloride resin (A) and a plasticizer (B). Further, an amount of each component of the polyvinyl chloride composition is expressed in parts by weight (pbw).

Specifically, an amount of the polyvinyl chloride resin (A) ranges from 30 parts by weight to 60 parts by weight, and preferably ranges from 35 parts by weight to 50 parts by weight (e.g., 42.85 parts by weight).

An amount of the plasticizer (B) ranges from 0.5 parts by weight to 5.0 parts by weight, and preferably ranges from 0.5 parts by weight to 3.0 parts by weight (e.g., 0.86 to 1.71 parts by weight).

It is worth mentioning that the polyvinyl chloride composition of the embodiment of the present disclosure further includes a fatty acid stabilizer (C).

The fatty acid stabilizer (C) is a composite formula and at least includes: a calcium fatty acid compound (C1), a zinc fatty acid compound (C2), a pentaerythritol ester compound (C3), and a β-diketone compound (C4). Further, a total amount of the fatty acid stabilizer (C) ranges from 1 part by weight to 8 parts by weight, and preferably ranges from 2 parts by weight to 6 parts by weight.

More specifically, an amount of the calcium fatty acid compound (C1) ranges from 0.05 parts by weight to 0.15 parts by weight (e.g., 0.07 to 0.09 parts by weight). An amount of the zinc fatty acid compound (C2) ranges from 0.18 parts by weight to 0.25 parts by weight (e.g., 0.18 to 0.22 parts by weight). An amount of the pentaerythritol ester compound (C3) ranges from 1.0 part by weight to 2.0 parts by weight (e.g., 1.0 to 1.3 parts by weight). An amount of the β-diketone compound (C4) ranges from 0.8 parts by weight to 1.8 parts by weight (e.g., 0.85 to 1.09 parts by weight).

Furthermore, the polyvinyl chloride composition of the present embodiment has a gelation time of not greater than 20 seconds, preferably between 15 seconds and 20 seconds.

Additionally, the polyvinyl chloride composition of the present embodiment has a thermal stability time of not less than 153 minutes at 180° C., and preferably between 153 minutes and 160 minutes.

Accordingly, the polyvinyl chloride composition of the present embodiment can improve the thermal resistance of calcium-zinc stabilizers, allowing the calcium-zinc stabilizers to remain stable during high-temperature processing and prevent the resin material from degrading. Additionally, the polyvinyl chloride composition of the present embodiment can address the problem of heavy metal toxicity in conventional PVC stabilizers (e.g., lead salt stabilizers, metal soap stabilizers, and organotin stabilizers), which pose risks to human health and environment, and meet the market demand for non-toxic, environmentally friendly materials.

It should be noted that the term “gelation time” mentioned in the embodiment of the present disclosure is defined as the time during a process of the polyvinyl chloride composition being transformed from a powder or granular state to a continuous and uniform molten state during heating. The process is a critical step in the transition of the polyvinyl chloride composition from a solid to a molten state, typically occurring during processing (e.g., extrusion or calendering), and has a significant impact on the quality of the final product. Gelation time is measured under standard temperature conditions, such as a high temperature between 180° C. and 200° C., using a rotational viscometer (e.g., a Brabender tester) to measure the time (usually in seconds) until the polyvinyl chloride composition reaches a uniform molten state. The shorter the gelation time is, the faster the polyvinyl chloride composition melts, so that the polyvinyl chloride composition is suitable for high-speed processing. Conversely, a long gelation time may lead to material decomposition or unevenness during processing. An appropriate gelation time ensures stable processing and consistency in product quality.

In the present embodiment, the gelation time can be measured, for example, in accordance with a standard test method of ASTM D794 or ASTM D2538, but the present disclosure is not limited thereto.

In the embodiment of the present disclosure, the term “thermal stability time” is defined as the time during which the polyvinyl chloride composition can maintain its structure and performance without significant degradation, such as color change or deterioration of physical properties, under high-temperature conditions. Thermal stability refers to the ability of the polyvinyl chloride composition to withstand high temperatures without decomposing or discoloring, which is crucial for PVC applications that require long-term and high-temperature processing. Thermal stability time is typically measured at high temperatures (e.g., 180° C. or higher) using a thermal stability tester or thermogravimetric analyzer (TGA) to measure the time before the PVC begins to decompose under high-temperature conditions. The test may include observing the color changes of the PVC sample (e.g., yellowing or blackening) under high temperatures.

The longer the thermal stability time is, the better the heat resistance of the resin material is, which can maintain the properties of the resin material during high-temperature processing. Thermal stability is critical for PVC products requiring high-temperature processing, such as extrusion or calendering. In the present embodiment, the thermal stability time of the polyvinyl chloride composition is more specifically defined as a dynamic thermal stability time measured according to ASTM D2538, with a duration of not less than 153 minutes at 180° C., and preferably between 155 minutes and 160 minutes.

Overall, gelation time is defined as the time required for the PVC material to transition to a uniform molten state during heating, affecting processing speed and material quality. Thermal stability time is defined as the time during which the PVC maintains stable performance without significant degradation at high temperatures, affecting the heat resistance of the resin material.

Furthermore, in some embodiments of the present disclosure, the composite formula of the fatty acid stabilizer (C) can optionally include at least one of a phosphite ester compound (C5), a dicarboxylic acid ester compound (C6), and hydrotalcite (C7).

An amount of the phosphite ester compound (C5) ranges from 1.0 part by weight to 2.0 parts by weight (e.g., 1.22 parts by weight). An amount of the dicarboxylic acid ester compound (C6) ranges from 0.18 parts by weight to 0.25 parts by weight (e.g., 0.22 parts by weight). An amount of the hydrotalcite (C7) ranges from 1.0 part by weight to 2.0 parts by weight (e.g., 1.3 parts by weight), but the present disclosure is not limited thereto.

In some embodiments of the present disclosure, the polyvinyl chloride composition can further include at least one of an ultraviolet absorber (D), an impact modifier (E), and an antioxidant (F).

An amount of the ultraviolet absorber (D) ranges from 3.0 parts by weight to 10 parts by weight, and preferably ranges from 5 parts by weight to 8 parts by weight (e.g., 6.43 parts by weight).

An amount of the impact modifier (E) ranges from 0.5 parts by weight to 5.0 parts by weight, and preferably ranges from 1 part by weight to 3.5 parts by weight (e.g., 2.14 parts by weight).

An amount of the antioxidant (F) ranges from 0.01 parts by weight to 2.0 parts by weight, and preferably ranges from 0.1 parts by weight to 0.5 parts by weight (e.g., 0.22 parts by weight).

It is worth noting that in the embodiment of the present disclosure, the amount of each component is expressed in parts by weight, rather than calculated as a mass percentage of a total amount of 100. The proportions of all components in the PVC composition are expressed in parts by weight relative to the polyvinyl chloride resin (A).

Specifically, the composition ratio can be expressed in two ways including “parts by weight” and “weight percentage (wt %).” The expression of “parts by weight” emphasizes the ratio between components without needing to total 100%. In the expression of “weight percentage (wt %)”, the upper limit of one component plus the lower limits of the other components must be less than or equal to 100%, and the lower limit of one component plus the upper limits of the other components must be greater than or equal to 100%. For example, 50 parts by weight of A component and 20 parts by weight of B component would convert to percentages as A=50/(50+20) %, and B=20/(50+20) %.

Accordingly, if the amounts of the above component are expressed in “weight percentage (wt %),” the amounts would be as follows. Based on a total weight of the polyvinyl chloride composition being 100 wt %, a content of the polyvinyl chloride resin (A) ranges from 50 wt % to 90 wt %, and preferably from 65 wt % to 80 wt %. A content of the plasticizer (B) ranges from 0.8 wt % to 8.5 wt %, and preferably from 0.8 wt % to 5.0 wt %. A content of the fatty acid stabilizer (C) ranges from 1.0 wt % to 13.5 wt %, and preferably from 3.3 wt % to 10 wt %. A content of the ultraviolet absorber (D) ranges from 5.0 wt % to 16.8 wt %, and preferably from 8.5 wt % to 13.5 wt %. A content of the impact modifier (E) ranges from 0.8 wt % to 8.3 wt %, and preferably from 1.6 wt % to 5.8 wt %. A content of the antioxidant (F) ranges from 0.01 wt % to 3.3 wt %, and preferably from 0.1 wt % to 0.8 wt %, but the present disclosure is not limited thereto.

The above describes the components and amounts of the polyvinyl chloride composition in the embodiment of the present disclosure. The material characteristics and functions of each component in the composition will be explained in more detail below.

The material characteristics of the polyvinyl chloride resin (A) are described as follows.

The polyvinyl chloride resin is the base material in the polyvinyl chloride composition. In the present embodiment, the polyvinyl chloride resin can be, for example, PVC powders, which can have, for example, a K value ranging from 45 to 80 (preferably from 55 to 72), an average degree of polymerization ranging from 500 to 2500 (preferably from 750 to 1300), an average particle size ranging from 50 micrometers to 500 micrometers (preferably from 100 micrometers to 300 micrometers), an apparent density ranging from 0.4 to 0.8 g/cc (preferably from 0.45 to 0.6 g/cc), and a volatile content of not greater than 0.3%.

The K value is tested according to DIN 53726, while the average degree of polymerization, apparent density, and volatile content are tested according to JIS-K6721. Accordingly, the polyvinyl chloride resin is suitable for manufacturing rigid materials such as plastic floor tiles, but the present disclosure is not limited thereto.

The material characteristics of the plasticizer (B) are described as follows.

The plasticizer is at least one material selected from the group consisting of: phthalate plasticizers (e.g., di(2-ethylhexyl) phthalate DEHP, dioctyl phthalate DOP, diisononyl phthalate DINP, diisodecyl phthalate DIDP, dibutyl phthalate DBP), non-phthalate plasticizers (e.g., dioctyl terephthalate DOTP, diisononyl cyclohexane-1,2-dicarboxylate DINCH, acetyl tributyl citrate ATBC, trioctyl trimellitate TOTM), phosphate plasticizers (e.g., triphenyl phosphate TPP, tricresyl phosphate TCP), epoxy plasticizers (e.g., epoxidized soybean oil ESO, epoxidized cottonseed oil ECO), polymeric plasticizers (e.g., polyester plasticizers), and citrate plasticizers (e.g., acetyl tributyl citrate ATBC, tributyl citrate TBC).

In the present embodiment, the plasticizer can include, for example, 0.5 parts by weight to 1.0 part by weight of a non-phthalate plasticizer (e.g., dioctyl terephthalate DOTP) and 1.5 parts by weight to 2 parts by weight of an epoxy plasticizer (e.g., epoxidized soybean oil ESO), but the present disclosure is not limited thereto.

The material characteristics of the fatty acid stabilizer (C) are described as follows.

As mentioned above, the fatty acid stabilizer (C) is a composite formula and at least includes: a calcium fatty acid compound (C1), a zinc fatty acid compound (C2), a pentaerythritol ester compound (C3), and a β-diketone compound (C4). Further, the fatty acid stabilizer (C) can optionally include at least one of a phosphite ester compound (C5), a dicarboxylic acid ester compound (C6), and hydrotalcite (C7).

The calcium fatty acid compound (C1) has a carbon chain length of C12 to C36 (preferably C12 to C20), a molar mass of 550 to 650 g/mol, a specific gravity of 1.0 to 1.60 g/cm³, a melting point of 120° C. to 170° C., and a moisture content of less than 2.0%. In the present embodiment, the calcium fatty acid compound can be, for example, calcium stearate (i.e., calcium octadecanoate), but the present disclosure is not limited thereto.

The zinc fatty acid compound (C2) has a carbon chain length of C12 to C36 (preferably C12 to C20), a molar mass of 550 to 650 g/mol, a specific gravity of 1.0 to 1.60 g/cm³, a melting point of 120° C. to 170° C., and a moisture content of less than 2.0%. In the present embodiment, the zinc fatty acid compound can be, for example, zinc stearate (i.e., zinc octadecanoate), but the present disclosure is not limited thereto.

The pentaerythritol ester compound (C3) is an ester compound formed by an ester reaction between pentaerythritol and different fatty acids or resin acids. The pentaerythritol ester compound is at least one material selected from the group consisting of: pentaerythritol tetraoleate, pentaerythritol tetrastearate, pentaerythritol tetraisostearate, pentaerythritol trioleate, pentaerythritol tetracaprate, pentaerythritol tetracaprylate, pentaerythritol tetracinnamate, pentaerythritol tetralinoleate, and a mixture of pentaerythritol tetraesters formed by the ester reaction between pentaerythritol and different fatty acids (e.g., oleic acid, stearic acid, or linoleic acid). In the present embodiment, the pentaerythritol ester compound can be, for example, pentaerythritol tetrastearate, but the present disclosure is not limited thereto.

The β-diketone compound (C4) can act as an auxiliary stabilizer, functioning synergistically with other stabilizers (e.g., metal salt stabilizers) to enhance the thermal stability of the PVC material. The β-diketone compound is at least one material selected from the group consisting of stearoyl benzoyl methane (SBM), octanoyl benzoyl methane (OBM), and dibenzoyl methane (DBM). In the present embodiment, the β-diketone compound is stearoyl benzoyl methane, but the present disclosure is not limited thereto.

The phosphite ester compound (C5) primarily acts as a chelating agent. When the phosphite ester compound is used alone, the phosphite ester compound does not exhibit significant stabilizing effects. However, when the phosphite ester compound is used together with metal soaps, the phosphite ester compound can be chelated with metal chlorides, so as to improve heat resistance, weather resistance, and maintain transparency. In the present embodiment, the phosphite ester compound does not contain bisphenol A, phenols, nonyl-phenols, or heavy metals such as Ba, Cd, and Pb, which meet environmental protection requirements.

Based on the above requirements, the phosphite ester compound is at least one material selected from the group consisting of tris(2-ethylhexyl) phosphite (TIOP), diisodecyl phosphite (PDDP), bis(2-ethylhexyl) phenyl phosphite, and tris(2-ethyl) hexyl phosphite. In the present embodiment, the phosphite ester compound can be tris(2-ethylhexyl) phosphite (TIOP), which exhibits good compatibility with calcium stearate, zinc stearate, pentaerythritol esters, and stearoyl benzoyl methane, and can effectively improve the thermal stability and weather resistance of the PVC material without affecting transparency of the PVC material.

The dicarboxylic acid ester compound (C6) provides functions of auxiliary stabilization and lubrication, particularly under high-temperature processing and usage conditions. The dicarboxylic acid ester compound can improve the heat resistance, weather resistance, and antioxidant properties of the PVC material. Specifically, the dicarboxylic acid ester compound works synergistically with other stabilizers, such as calcium stearate and zinc stearate, to stabilize the PVC composition and prevent the resin material from degrading or discoloring during high-temperature processing.

The dicarboxylic acid ester compound is at least one material selected from the group consisting of dioctyl adipate (DOA), diisononyl adipate (DINA), dioctyl sebacate (DOS), diisononyl sebacate (DINS), and dinonyl adipate. In the present embodiment, the dicarboxylic acid ester compound can be dioctyl adipate (DOA), but the present disclosure is not limited thereto.

The hydrotalcite (C7) is an inorganic compound that can be used as a heat stabilizer, particularly used as an auxiliary stabilizer in a non-toxic, environmentally friendly PVC composition. The hydrotalcite can improve the thermal stability and weather resistance of the PVC material. Additionally, during processing the PVC material, the PVC material may be decomposed to release hydrogen chloride gas (HCl) during a high-temperature process, which accelerates the degradation of the PVC material. The hydrotalcite can absorb and neutralize the released HCl gas, to prevent the PVC material from degrading and extend lifespan of the PVC material.

In some embodiments of the present disclosure, the hydrotalcite is at least one material selected from the group consisting of magnesium-aluminum hydrotalcite, magnesium-zinc hydrotalcite, calcium-aluminum hydrotalcite, zinc-aluminum hydrotalcite, magnesium-iron hydrotalcite, and zinc-magnesium-aluminum hydrotalcite. In the present embodiment, the hydrotalcite is magnesium-aluminum hydrotalcite, but the present disclosure is not limited thereto. Alternatively, the hydrotalcite can be a layered double hydroxide (LDH), which can effectively absorb and neutralize acidic gases (e.g., hydrogen chloride produced during PVC decomposition), thereby improving the thermal stability of the PVC material.

Overall, the composite formula of the fatty acid stabilizer (C) in the embodiment of the present disclosure can effectively improve the thermal stability of the PVC material through synergistic effects. The fatty acid stabilizer can absorb hydrogen chloride (HCl) generated during the process and chelate zinc chloride (ZnCl₂), preventing PVC material degradation and avoiding the phenomenon of zinc burning.

The polyvinyl chloride composition in the embodiment of the present disclosure is free from bisphenol A, phenols, nonylphenols, and heavy metals such as Ba, Cd, and Pb, which ensures compliance with current environmental standards and makes the composition suitable for products intended for human contact, particularly PVC floor tiles.

Specifically, the polyvinyl chloride composition of the embodiment of the present disclosure includes the fatty acid stabilizer, which can be composed of calcium stearate, zinc stearate, magnesium-aluminum hydrotalcite, pentaerythritol esters, and stearoyl benzoyl methane. These components synergistically enhance the thermal stability of the PVC material and effectively reduce the degradation of the PVC material during high-temperature processing.

Regarding the acid neutralization and chelation mechanism mentioned in the embodiment of the present disclosure, the high temperature during the PVC processing may cause the decomposition of the PVC material, leading to the release of HCl, which accelerates the degradation of the PVC material. The calcium salt, such as calcium stearate, reacts with HCl to form calcium chloride (CaCl₂)), neutralizing the acidic substances. Simultaneously, the zinc salt, such as zinc stearate, reacts with HCl to form zinc chloride (ZnCl₂). The fatty acid in the fatty acid stabilizer, such as stearic acid, chelates ZnCl₂, forming stable chelates that reduce the catalytic activity of ZnCl₂, thus preventing the degradation or blackening of the PVC material. The thermal stability of the polyvinyl chloride composition is enhanced. Through the synergistic action of the calcium-zinc stabilizer, the thermal stability time of the PVC material is effectively extended, so as to prevent the degradation of the PVC material during prolonged high-temperature processing.

The polyvinyl chloride composition of the embodiment of the present disclosure can be used in the production of rigid multilayer composite PVC plastic floor tiles through a hot-pressing process, which is simple and does not require the traditional adhesive bonding technique. Additionally, since the polyvinyl chloride composition of the embodiment of the present disclosure does not contain harmful substances such as phthalates and formaldehyde, the production process is more environmentally friendly, and the product quality is stable.

As mentioned above, in some embodiments of the present disclosure, the polyvinyl chloride composition can optionally include at least one of an ultraviolet absorber (D), an impact modifier (E), and an antioxidant (F).

The ultraviolet absorber (D) can protect the PVC material from ultraviolet damage, preventing degradation, discoloration, or deterioration occurred on the PVC material when exposed to prolonged sunlight or other ultraviolet radiation. The ultraviolet absorber is at least one material selected from the group consisting of titanium dioxide (TiO₂), zinc oxide (ZnO), and benzotriazole compounds. In the present embodiment, the ultraviolet absorber is titanium dioxide, but the present disclosure is not limited thereto.

The impact modifier (E) enhances the toughness and impact resistance of the PVC material. The impact modifier is at least one material selected from the group consisting of chlorinated polyethylene (CPE), acrylonitrile-butadiene-styrene (ABS) copolymers, acrylate copolymers, and methyl methacrylate-butadiene-styrene (MBS). In the present embodiment, the impact modifier is chlorinated polyethylene (CPE), but the present disclosure is not limited thereto.

The antioxidant (F) can prevent the degradation of the PVC material due to oxidation during processing or use.

The antioxidant is at least one material selected from the group consisting of hindered phenol antioxidants (e.g., butylated hydroxytoluene, BHT), phosphite antioxidants (e.g., tris(2,4-di-tert-butylphenyl) phosphite, TDP), thioether antioxidants (e.g., dilauryl thiodipropionate, DLTDP), and amine antioxidants (e.g., dioctylamine, DOA).

In the present embodiment, the antioxidant is a phosphite antioxidant (e.g., TIOP), but the present disclosure is not limited thereto.

Overall, the polyvinyl chloride composition in the embodiment of the present disclosure, which utilizes calcium-zinc-based fatty acid stabilizers, effectively improves the thermal stability of the PVC material during polymer processing (e.g., calendering, blow molding, casting, or T-die extrusion) to form a resin film, thereby preventing phenomena such as zinc burning and avoiding PVC resin degradation or blackening. Furthermore, through formulation adjustments, the polyvinyl chloride composition of the embodiment of the present disclosure can maintain the gelation time within an ideal range, at least comparable to conventional barium-zinc stabilizers.

Subsequently, since the resin film formed of the polyvinyl chloride composition of the embodiment of the present disclosure exhibit excellent thermal stability, a multilayer composite PVC floor tile with environmentally friendly and non-toxic properties can be produced through a hot-pressing method. The multilayer composite PVC floor tile has superior mechanical properties and has no need for an adhesive coating process traditionally required for environmentally friendly PVC films, which suffer from poor thermal stability.

### [Plastic Floor Tile]

Another embodiment of the present disclosure provides a plastic floor tile that can be formed of the polyvinyl chloride composition mentioned above, and the preparation process includes steps of S110 to S150, but the present disclosure is not limited thereto.

Step S110 is to implement a material preparation operation that includes providing the polyvinyl chloride composition as described above.

Step S120 is to implement a material mixing operation that includes feeding the various components of the polyvinyl chloride composition into a mixer according to the specified proportions mentioned above to ensure uniform dispersion of each component. This process can be carried out at room temperature, or moderate heating on the components can be applied to enhance the mixing effect. After mixing, the operation is essential to ensure that the components are thoroughly blended with no delamination.

Step S130 is to implement a plasticization and gelation operation that includes plasticizing the polyvinyl chloride composition mixed in a mixer. During the plasticization process, the material of the polyvinyl chloride composition gradually melts from solid granules, forming a uniform molten PVC substance, and this process is referred to as gelation. A plasticization temperature of the plasticization process is between 180° C. and 200° C. to ensure the PVC melts without decomposition.

Step S140 is to implement a calendering molding operation or an extrusion molding operation.

For the calendering molding operation, the molten PVC substance is passed through a calendering machine to form a film or a sheet with a desired thickness. The calendering machine consists of multiple rollers, and the PVC material is gradually rolled out into a film through multiple rollers, with thickness adjustable as needed, typically between 2 to 5 mm for floor tiles.

Alternatively, for the extrusion molding operation (T-die extrusion), the polyvinyl chloride composition is directly extruded into uniform sheets, which can then be further processed into floor tiles.

Step S150 is to implement a plastic floor tile preparing operation that includes: laminating the calendered or extruded films (or sheets) into a multilayer composite structure by using a hot-pressing method, followed by cooling and cutting to form PVC plastic floor tiles with suitable size. The lamination process in the present disclosure does not require traditional adhesive bonding techniques, thereby reducing the use of harmful substances.

### [Experimental Data and Test Results]

The following details the content of the present disclosure by referring to Exemplary Examples 1 to 3 and Comparative Examples 1 to 4. However, the following examples are only provided to help understand the present disclosure and are not intended to limit the scope of the present disclosure. The Exemplary Examples are groups that demonstrate the technical effects of the present disclosure, while the Comparative Examples are groups with relatively poor experimental results.

In Exemplary Example 1, a polyvinyl chloride composition was prepared according to Table 1, containing: 42.85 parts by weight of PVC powders (corresponding to the polyvinyl chloride resin A), 0.86 parts by weight of dioctyl terephthalate (DOTP) plasticizer (corresponding to the plasticizer B1), 1.71 parts by weight of epoxidized soybean oil (corresponding to the plasticizer B2), 0.09 parts by weight of calcium stearate (corresponding to the calcium fatty acid C1), 0.22 parts by weight of zinc stearate (corresponding to the zinc fatty acid C2), 1.30 parts by weight of pentaerythritol tetrastearate (corresponding to the pentaerythritol ester C3), 1.09 parts by weight of stearoyl benzoyl methane (corresponding to the β-diketone compound C4), 1.22 parts by weight of tris(2-ethylhexyl) phosphite (corresponding to the phosphite ester compound C5), 0.22 parts by weight of dioctyl adipate (corresponding to the dicarboxylic acid ester C6), 1.30 parts by weight of magnesium-aluminum hydrotalcite (corresponding to the hydrotalcite C7), 6.43 parts by weight of titanium dioxide (corresponding to the ultraviolet absorber D), 2.14 parts by weight of chlorinated polyethylene (CPE) (corresponding to the impact modifier E), and 0.22 parts by weight of tris(2-ethylhexyl) phosphite (TIOP) (corresponding to the antioxidant F). The components of the polyvinyl chloride composition were fed into a mixer for blending, and the mixed polyvinyl chloride composition was subjected to tests, such as gelation time and thermal stability time at 180° C. The test methods for gelation time and thermal stability time have been described above, and will not be reiterated herein.

The preparation methods for Exemplary Examples 2 and 3 are similar to that of Exemplary Example 1, with the difference being variations in the amounts of materials used.

The preparation method for Comparative Example 1 is similar to that of Exemplary Example 1, with the difference being that the stabilizer in Comparative Example 1 is a commercially available barium-zinc stabilizer used for comparison, and the polyvinyl chloride composition of Comparative Example 1 does not include the components C1 to C7 (fatty acid stabilizers) from Exemplary Example 1. The barium-zinc stabilizer can be the GS-136 model barium-zinc stabilizer purchased from Yuan Plastics Industrial Co., Ltd.

The preparation method for Comparative Example 2 is similar to that of Exemplary Example 1, with the difference being that no calcium stearate (calcium fatty acid C1) and zinc stearate (zinc fatty acid C2) were added in the PVC composition of Comparative Example 2.

The preparation method for Comparative Example 3 is similar to that of Exemplary Example 1, with the difference being that no stearoyl benzoyl methane (β-diketone compound C4) was added in the PVC composition of Comparative Example 3.

The preparation method for Comparative Example 4 is similar to that of Exemplary Example 1, with the difference being that no pentaerythritol tetrastearate (pentaerythritol ester C3) was added in the PVC composition of Comparative Example 4.

TABLE 1

| Polyvinyl Chloride | | Exemplary | Exemplary | Exemplary |
|---|---|---|---|---|
| Composition | | Example 1 | Example 2 | Example 3 |
| PVC Powders (Parts by Weight) | | 42.85 | 42.85 | 42.85 |
| (Polyvinyl Chloride Resin A) | | | | |
| Dioctyl Terephthalate (DOTP) | | 0.86 | 0.86 | 0.86 |
| Plasticizer (Parts by Weight) | | | | |
| (Plasticizer B1) | | | | |
| Epoxidized Soybean Oil | | 1.71 | 1.71 | 1.71 |
| (Parts by Weight) (Plasticizer B2) | | | | |
| Calcium Stearate (Parts by Weight) | | 0.09 | 0.07 | 0.09 |
| (Calcium Fatty Acid C1) | | | | |
| Zinc Stearate (Parts by Weight) | | 0.22 | 0.18 | 0.22 |
| (Zinc Fatty Acid C2) | | | | |
| Pentaerythritol Tetrastearate | | 1.30 | 1.30 | 1.00 |
| (Parts by Weight) | | | | |
| (Pentaerythritol Ester C3) | | | | |
| Stearoyl Benzoyl Methane | | 1.09 | 1.09 | 0.85 |
| (Parts by Weight) | | | | |
| (β-Diketone Compound C4) | | | | |
| Tris(2-ethylhexyl) Phosphite | | 1.22 | 1.22 | 1.22 |
| (Parts by Weight) | | | | |
| (Phosphite ester compound C5) | | | | |
| Dioctyl Adipate (Parts by Weight) | | 0.22 | 0.22 | 0.22 |
| (Dicarboxylic Acid Ester C6) | | | | |
| Magnesium-Aluminum | | 1.30 | 1.30 | 1.30 |
| Hydrotalcite (Parts by Weight) | | | | |
| (Hydrotalcite C7) | | | | |
| Titanium Dioxide | | 6.43 | 6.43 | 6.43 |
| (Parts by Weight) | | | | |
| (Ultraviolet Absorber D) | | | | |
| Chlorinated Polyethylene (CPE) | | 2.14 | 2.14 | 2.14 |
| (Parts by Weight) | | | | |
| (Impact Modifier E) | | | | |
| Tris(2-ethylhexyl) Phosphite | | 0.22 | 0.22 | 0.22 |
| (TIOP) (Parts by Weight) | | | | |
| (Antioxidant F) | | | | |
| Barium-Zinc Stabilizer | | 0.00 | 0.00 | 0.00 |
| (Commercial) (Parts by Weight) | | | | |
| Test 1 - | | 19 | 19 | 20 |
| Gelation Time (seconds) | | | | |
| Test 2 - | | 157.6 | 154.0 | 156.1 |
| Thermal Stability Time at 180° C. | | | | |
| (minutes) | | | | |
| | Compar- | Compar- | Compar- | Compar- |
| Polyvinyl Chloride | ative | ative | ative | ative |
| Composition | Example 1 | Example 2 | Example 3 | Example 4 |
| PVC Powder | 42.85 | 42.85 | 42.85 | 42.85 |
| (Parts by Weight) | | | | |
| (Polyvinyl Chloride | | | | |
| Resin A) | | | | |
| Dioctyl | 0.86 | 0.86 | 0.86 | 0.86 |
| Terephthalate | | | | |
| (DOTP) Plasticizer | | | | |
| (Parts by Weight) | | | | |
| (Plasticizer B1) | | | | |
| Epoxidized Soybean | 1.71 | 1.71 | 1.71 | 1.71 |
| Oil (Parts by Weight) | | | | |
| (Plasticizer B2) | | | | |
| Calcium Stearate | 0.00 | 0.00 | 0.09 | 0.09 |
| (Parts by Weight) | | | | |
| (Calcium Fatty Acid | | | | |
| C1) | | | | |
| Zinc Stearate | 0.00 | 0.00 | 0.22 | 0.22 |
| (Parts by Weight) | | | | |
| (Zinc Fatty Acid C2) | | | | |
| Pentaerythritol | 0.00 | 1.30 | 1.30 | 0.00 |
| Tetrastearate | | | | |
| (Parts by Weight) | | | | |
| (Pentaerythritol Ester | | | | |
| C3) | | | | |
| Stearoyl Benzoyl | 0.00 | 1.09 | 0.00 | 1.09 |
| Methane (Parts by | | | | |
| Weight) (β-Diketone | | | | |
| Compound C4) | | | | |
| Tris(2-ethylhexyl) | 0.00 | 1.22 | 1.22 | 1.22 |
| Phosphite (Parts by | | | | |
| Weight) (Phosphite | | | | |
| ester compound C5) | | | | |
| Dioctyl Adipate | 0.00 | 0.22 | 0.22 | 0.22 |
| (Parts by Weight) | | | | |
| (Dicarboxylic Acid | | | | |
| Ester C6) | | | | |
| Magnesium- | 0.00 | 1.30 | 1.30 | 1.30 |
| Aluminum | | | | |
| Hydrotalcite | | | | |
| (Parts by Weight) | | | | |
| (Hydrotalcite C7) | | | | |
| Titanium Dioxide | 6.43 | 6.43 | 6.43 | 6.43 |
| (Parts by Weight) | | | | |
| (Ultraviolet Absorber | | | | |
| D) | | | | |
| Chlorinated | 2.14 | 2.14 | 2.14 | 2.14 |
| Polyethylene (CPE) | | | | |
| (Parts by Weight) | | | | |
| (Impact Modifier E) | | | | |
| Tris(2-ethylhexyl) | 0.22 | 0.22 | 0.22 | 0.22 |
| Phosphite (TIOP) | | | | |
| (Parts by Weight) | | | | |
| (Antioxidant F) | | | | |
| Barium-Zinc | 2.23 | 0.00 | 0.00 | 0.00 |
| Stabilizer | | | | |
| (Commercial) | | | | |
| (Parts by Weight) | | | | |
| Physical Property 1 - | 21 | 32 | 28 | 27 |
| Gelation Time | | | | |
| (seconds) | | | | |
| Physical Property 2 - | 150.8 | 120.2 | 124.4 | 130.2 |
| Thermal Stability | | | | |
| Time at 180° C. | | | | |
| (minutes) | | | | |

The test results show that the polyvinyl chloride composition of Exemplary Example 1 has a thermal stability time of 157.6 minutes at 180° C. and a gelation time of 19 seconds, which is superior to the traditional barium-zinc stabilizer formula in Comparative Example 1. Additionally, the polyvinyl chloride composition of Exemplary Example 1 effectively prevents material discoloration, blackening, and performance degradation, demonstrating excellent processability and thermal stability.

The test results of Exemplary Examples 1 to 3 show that the polyvinyl chloride compositions in the above formulas all exhibit a gelation time of not greater than 20 seconds and a thermal stability time of not less than 153 minutes at 180° C., which are significantly better than the test results of Comparative Examples 1 to 4.

The above experimental results show that the polyvinyl chloride composition using the specific fatty acid stabilizer composite formula exhibits better gelation time and thermal stability time, effectively improving the heat resistance of calcium-zinc stabilizers. This allows the material to remain stable during high-temperature processing, preventing degradation, and also addresses the issues of heavy metal toxicity in existing PVC stabilizers (e.g., lead salt stabilizers, metal soap stabilizers, and organotin stabilizers), which pose hazards to human health and the environment. This meets the market demand for non-toxic and environmentally friendly materials.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A polyvinyl chloride composition suitable for production of plastic floor tiles, comprising following components based on parts by weight:
a polyvinyl chloride resin, in an amount ranging from 30 parts by weight to 60 parts by weight;
a plasticizer, in an amount ranging from 0.5 parts by weight to 5.0 parts by weight; and
a fatty acid stabilizer,
wherein the fatty acid stabilizer is a composite formula and at least includes: a calcium fatty acid compound, a zinc fatty acid compound, a pentaerythritol ester compound, and a β-diketone compound;
wherein a total amount of the fatty acid stabilizer ranges from 1 part by weight to 8 parts by weight;
wherein the polyvinyl chloride composition has a gelation time of not greater than 20 seconds and a thermal stability time of not less than 153 minutes at 180° C.

2. The polyvinyl chloride composition according to claim 1, wherein, in the fatty acid stabilizer, an amount of the calcium fatty acid compound ranges from 0.05 parts by weight to 0.15 parts by weight, an amount of the zinc fatty acid compound ranges from 0.18 parts by weight to 0.25 parts by weight, an amount of the pentaerythritol ester compound ranges from 1.0 part by weight to 2.0 parts by weight, and an amount of the β-diketone compound ranges from 0.8 parts by weight to 1.8 parts by weight.

3. The polyvinyl chloride composition according to claim 1, wherein the fatty acid stabilizer includes at least one of:
a phosphite ester compound, in an amount ranging from 1.0 part by weight to 2.0 parts by weight;
a dicarboxylic acid ester compound, in an amount ranging from 0.18 parts by weight to 0.25 parts by weight; or
a hydrotalcite, in an amount ranging from 1.0 part by weight to 2.0 parts by weight.

4. The polyvinyl chloride composition according to claim 1, further comprising at least one of following components by parts by weight:
an ultraviolet absorber, in an amount ranging from 3.0 parts by weight to 10 parts by weight;
an impact modifier, in an amount ranging from 0.5 parts by weight to 5.0 parts by weight; or
an antioxidant, in an amount ranging from 0.01 parts by weight to 2.0 parts by weight.

5. The polyvinyl chloride composition according to claim 1, wherein the polyvinyl chloride resin has a K value ranging from 45 to 80, an average degree of polymerization ranging from 500 to 2,500, an apparent density ranging from 0.4 to 0.8 g/cc, and a volatile content of not greater than 0.3%.

6. The polyvinyl chloride composition according to claim 1, wherein the plasticizer is at least one material selected from the group consisting of phthalate plasticizers, non-phthalate plasticizers, phosphate plasticizers, epoxy plasticizers, polymeric plasticizers, and citrate plasticizers.

7. The polyvinyl chloride composition according to claim 6, wherein the plasticizer includes: 0.5 parts by weight to 1.0 part by weight of the non-phthalate plasticizer, and 1.5 parts by weight to 2 parts by weight of the epoxy plasticizer.

8. The polyvinyl chloride composition according to claim 1, wherein the calcium fatty acid compound and the zinc fatty acid compound each independently have a carbon chain length of C12 to C36, a molar mass of 550 g/mol to 650 g/mol, a specific gravity of 1.0 g/cm³ to 1.60 g/cm³, and a melting point of 120° C. to 170° C.

9. The polyvinyl chloride composition according to claim 1, wherein the β-diketone compound is at least one material selected from the group consisting of stearoyl benzoyl methane, octanoyl benzoyl methane, and dibenzoyl methane.

10. A plastic floor tile formed of the polyvinyl chloride composition according to claim 1.
